(19) United States
(12) Patent Application Publication
(10) Pub. No.: US 2025/0280968 A1
(43) Pub. Date: Sep. 11, 2025

(54) MULTIPORT AIRFLOW CONTROL ASSEMBLY FOR AN AIR CUSHION

(71) Applicant: PERMOBIL, INC., Lebanon, TN (US)

(72) Inventors: Duane Niemeyer, Aviston, IL (US); Chad Stuemke, Murphysboro, IL (US); David Hopp, Edwardsville, IL (US); Kevin Meier, Saint Louis, MO (US)

(21) Appl. No.: 18/600,061

(22) Filed: Mar. 8, 2024

(51) Int. Cl. A47C 27/10; A47C 27/08

(52) U.S. Cl. CPC A47C 27/10; A47C 27/082; A47C 27/083

(57) ABSTRACT

A multiport airflow control manifold assembly includes a manifold assembly defining a first air channel, a second air channel, and a third air channel. A first first port and a first second port are fluidly connected to the first air channel. A second first port and a second second port are fluidly connected to the second air channel. A third first port and a third second port are fluidly connected to the third air channel. A seal member is fluidly connected to the manifold assembly. The seal member is configured to move between a plurality of seal configuration. In a first seal configuration, the seal member is configured to fluidly isolate the first air channel, the second air channel, and the third air channel. In a second seal configuration, the seal member is configured to fluidly connect the first air channel, the second air channel, and the third air channel.

### FIELD OF THE DISCLOSURE

The present disclosure relates to an inflatable air cushion. More specifically, the present disclosure relates to a multiport airflow control assembly for use with an inflatable air cushion having a plurality of inflation zones. The airflow control assembly is configured to facilitate inflation, deflation, and to selectively fluidly connect different combinations of inflation zones to facilitate improved adjustability and customization of the inflatable air cushion for a user.

### BACKGROUND

Individuals who are confined to wheelchairs are at higher risk of tissue breakdown and the development of pressure sores, which can be difficult to treat and/or cure. In certain circumstances, much of an individual's weight can concentrate in the region of the ischium, which includes the ischial tuberosity, or the bony prominence of the buttocks. Without regular movement, the flow of blood to the skin tissue in these regions can decrease, leading to the tissue damage and the development of pressure sores. Inflatable cellular air cushions are generally known to improve distribution of weight and thus provide protection from the occurrence of tissue damage and pressure sores. These cushions can include an array of air cells that project upwardly from a common base. Within the base the air cells are configured to communicate with each other, and thus, all exist at the same internal pressure. Hence, each air cell exerts essentially the same restoring force against the buttocks, irrespective of the extent to which it is deflected. U.S. Pat. No. 4,541,136 discloses such a cellular cushion currently manufactured and sold by Permobil, Inc. of Lebanon, Tennessee, USA for use on wheelchairs. The air cells can be separated into a plurality of air zones. What is needed is an improvement in a valve system for use with the air cushion that allows for remote inflation and deflation of one or more air zones, while also integrating functionality to selectively fluidly connect (or disconnect) one of more air zones for either separate or grouped remote inflation and deflation.

### SUMMARY

In one example of an embodiment, a multiport airflow control manifold assembly includes a valve assembly including a manifold assembly defining a first air channel, a second air channel, and a third air channel. A first first port is fluidly connected to first air channel. A first second port is fluidly connected to the first air channel. A second first port is fluidly connected to second air channel. A second second port is fluidly connected to the second air channel. A third first port is fluidly connected to third air channel. A third second port is fluidly connected to the third air channel. An airflow control assembly is fluidly connected to the manifold assembly. The airflow control assembly includes a seal member configured to move between a first seal configuration and a second seal configuration. In the first seal configuration, the seal member is configured to fluidly isolate the first air channel, the second air channel, and the third air channel. In the second seal configuration, the seal member is configured to fluidly connect the first air channel, the second air channel, and the third air channel.

In another example of an embodiment, a multiport airflow control manifold assembly is configured to connect an air supply assembly to a cellular cushion, the multiport airflow control manifold assembly includes a manifold assembly defining a first air channel, a second air channel, and a third air channel. A first first port and a first second port are fluidly connected to the first air channel. A second first port and a second second port are fluidly connected to the second air channel. A third first port and a third second port fluidly are connected to the third air channel. An airflow control assembly is fluidly connected to the manifold assembly. The airflow control assembly includes a valve body fluidly connected to the first air channel, the second air channel, and the third air channel, and a seal member configured to move relative to the valve body between a first position and a second position. In the first position, the seal member is configured to fluidly isolate the first air channel, the second air channel, and the third air channel. In the second position, the seal member is configured to fluidly isolate the first air channel, and fluidly connect the second air channel and the third air channel.

Other aspects of the disclosure will become apparent by consideration of the detailed description and accompanying drawings.

### BRIEF DESCRIPTION OF THE DRAWINGS

FIG. 1 is a perspective view of an example of an embodiment of a cellular cushion and an embodiment of a multiport airflow control manifold assembly attached thereto.

FIG. 2 is a plan view of a top side of the cellular cushion of FIG. 1.

FIG. 3 is a plan view of the cellular cushion of FIG. 2 illustrating a plurality of inflation zones that are separated by a plurality of imaginary axes.

FIG. 4 is a plan view of a bottom side of the cellular cushion of FIG. 1.

FIG. 5 is an enhanced view of a multiport airflow control manifold assembly attached to the cellular cushion, as viewed from a bottom side of the cellular cushion and taken along line 5-5 of FIG. 4.

FIG. 6 is a perspective view of the multiport airflow control manifold assembly and a first portion of an air supply assembly shown detached from the cellular cushion of FIG. 1.

FIG. 7 is a perspective view of the multiport airflow control manifold assembly and first portion of the air supply assembly shown in FIG. 6, illustrating a cushion engagement end of the multiport airflow control manifold assembly.

FIG. 8 is an enhanced view of the multiport airflow control manifold assembly, taken along line 8-8 of FIG. 7.

FIG. 9 is a partially exploded perspective view of the multiport airflow control manifold assembly of FIG. 6, illustrating a first housing member of a housing assembly detached from a second housing member to show a valve assembly received and retained therein.

FIG. 10 is a partially exploded view of the multiport airflow control manifold assembly of FIG. 6, illustrating the valve assembly removed from the first and second housing members of the housing assembly.

FIG. 11 is a perspective view of the valve assembly of the multiport airflow control manifold assembly of FIG. 6 shown with the housing assembly removed for clarity.

FIG. 12 is a perspective view of the valve assembly of FIG. 11 shown with the air supply lines and manifold connector member removed for clarity.

FIG. 13 is a partially exploded perspective view of the valve assembly of FIG. 12 illustrating a manifold assembly with a first manifold member detached from a second manifold member.

FIG. 14 is a cross-sectional view of an airflow control assembly of the valve assembly of FIG. 12, taken along line 14-14 of FIG. 13.

FIG. 15 is a cross-sectional view of the airflow control assembly of FIG. 14 showing the seal member removed to illustrate apertures defined by a valve body to fluidly connect an associated air channel to the valve body.

FIG. 16 is a perspective view of a first portion and a second portion of the air supply assembly shown in a disengaged configuration and illustrating a first coupling member.

FIG. 17 is a perspective view of a first portion and a second portion of the air supply assembly shown in a disengaged configuration and illustrating a second coupling member.

FIG. 18 is a schematic diagram of an example of an embodiment of a remote air source assembly coupled to the second portion of the air supply assembly.

FIG. 19 is a schematic diagram of another example of an embodiment of a cellular cushion, a multiport airflow control manifold assembly, an air supply assembly, and a remote air source assembly depicting the cellular cushion with two inflation zones.

FIG. 20 is a schematic diagram of another example of an embodiment of a cellular cushion, a multiport airflow control manifold assembly, an air supply assembly, and a remote air source assembly depicting the cellular cushion with three inflation zones.

FIG. 21 is a schematic diagram of another example of an embodiment of a cellular cushion, a multiport airflow control manifold assembly, an air supply assembly, and a remote air source assembly depicting the cellular cushion with one inflation zone.

Before embodiments of the disclosure are explained in detail, it is to be understood that the disclosure is not limited in its application to the details of construction and the arrangement of components set forth in the following description or illustrated in the accompanying drawings. The disclosure is capable of supporting other embodiments and of being practiced or of being carried out in various ways.

### DETAILED DESCRIPTION

The present disclosure is directed to an embodiment of a multiport airflow control manifold assembly 100 configured for operation with a cellular cushion 10. The multiport airflow control manifold assembly 100 is configured to facilitate selective inflation and/or deflation of each of a plurality of inflation zones 30, 34, 38, 42 of the cellular cushion 10. The inflation and/or deflation can be in response to a detected or targeted pressure in the associated plurality of inflation zones 30, 34, 38, 42. In addition, the multiport airflow control manifold assembly 100 is configured to selectively fluidly connect and/or fluidly isolate different combinations of the plurality of inflation zones 30, 34, 38, 42 of the cellular cushion 10.

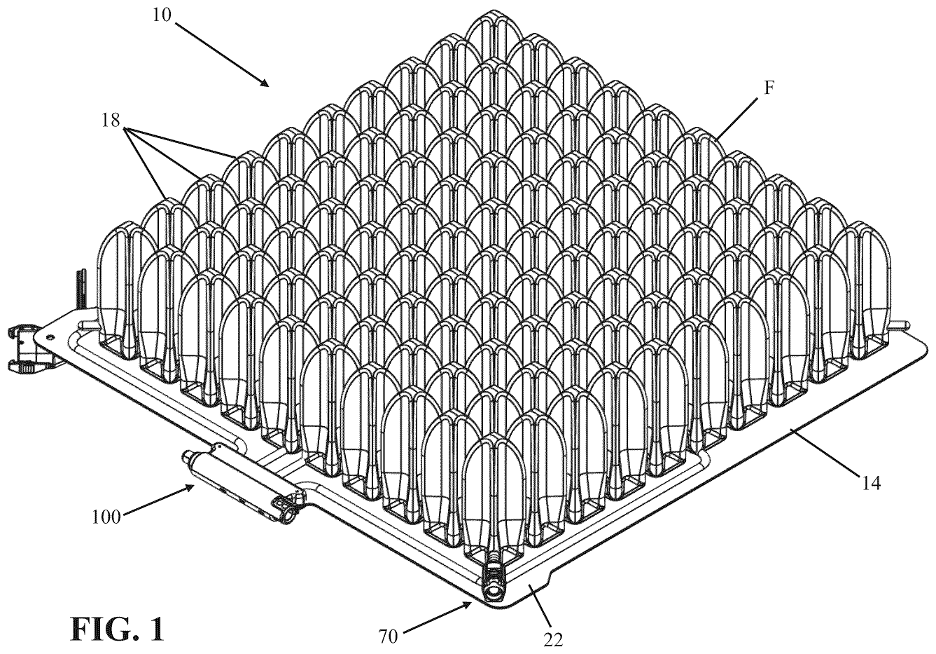

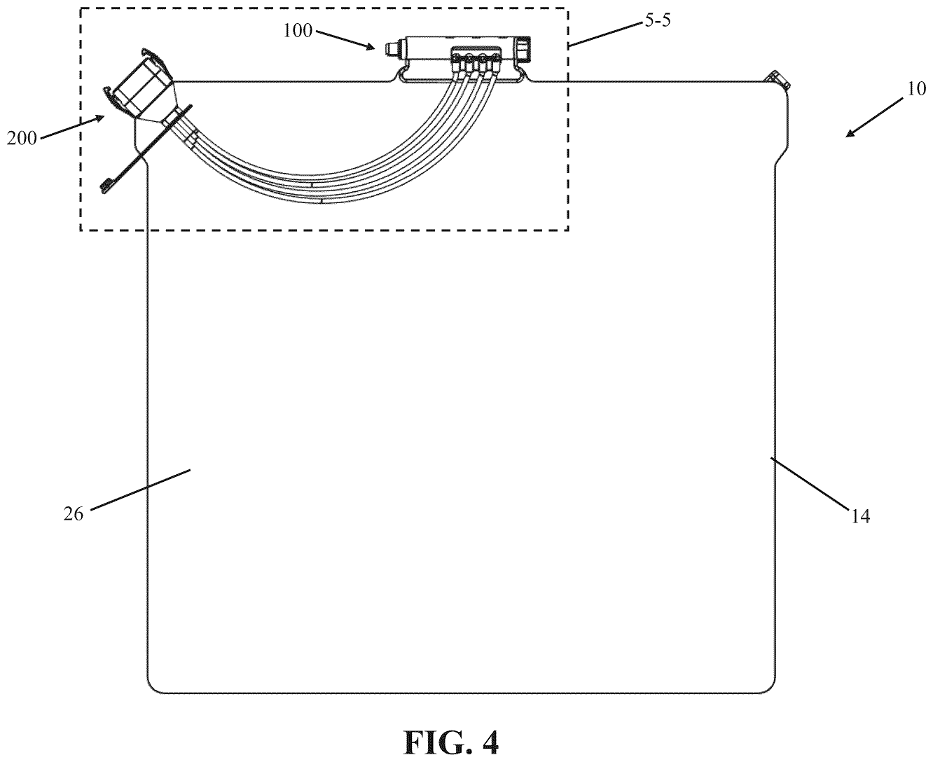

With reference now to the figures, FIG. 1 is a perspective view of an example of an embodiment of a cellular cushion 10 (also referred to as a cellular air cushion 10). The cellular cushion 10 includes a base 14 and a plurality of air cells 18. The base 14 is formed of an upper layer 22 and a lower layer 26 (shown in FIG. 4). The upper layer 22 can be coupled to the lower layer 26 (or backing layer 26) by a suitable adhesive. In the illustrated embodiment, the upper layer 22 can be formed of a first material while the lower layer 26 can be formed of a second, different material. In one example of an embodiment, the upper layer 22 can be formed of a flexible neoprene, while the lower layer 26 can be formed of polyurethane. In other examples of embodiments, the upper layer 22 and the lower layer 26 can be formed of any material (or combination of materials) suitable for operation of the cellular cushion 10 as described herein. An example of the cellular cushion 10 is disclosed in U.S. Pat. No. 4,541,136, the contents of which is hereby incorporated by reference in its entirety.

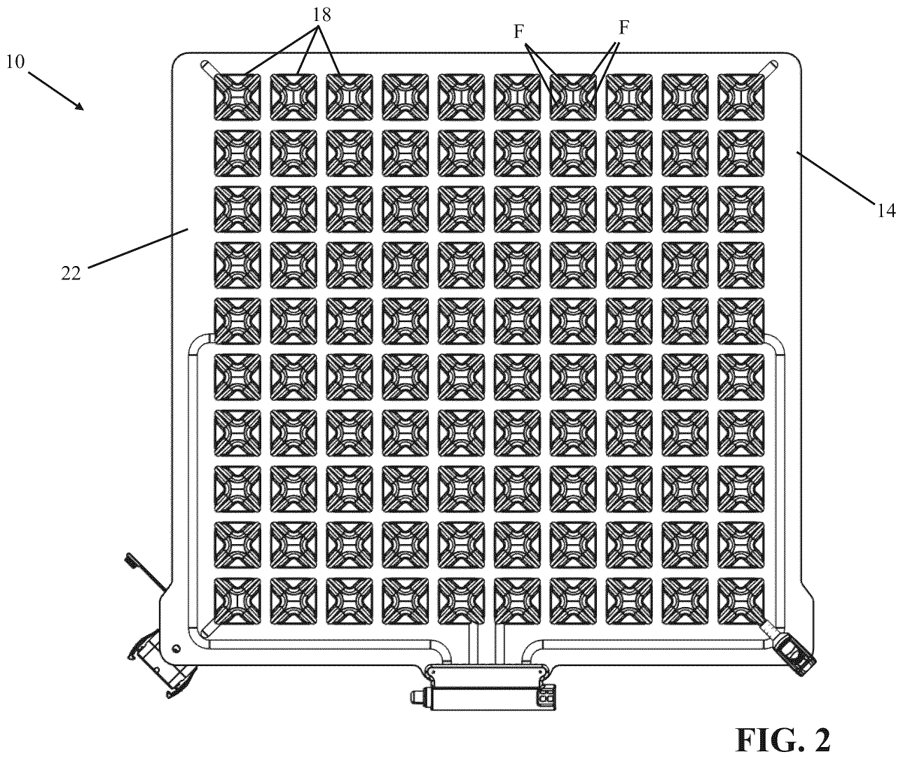

With reference to FIGS. 1-2, the plurality of air cells 18 project away from the base 14. The plurality of air cells 18 are molded into the upper layer 22, and thus are defined by the upper layer 22. In addition, the upper layer 22 interconnects the plurality of air cells 18. Each of the plurality of air cells 18 include four fins F. In other examples of embodiments, each of the plurality of air cells 18 can have any suitable configuration, including but not limited to air cells 18 having any number of fins, any number of sides, or having no fins (e.g., cylindrical cells, cubical cells, rounded cells, etc.).

The plurality of air cells 18 are arranged on the upper layer 22 in a plurality of longitudinal and transverse rows. As such, each air cell 18 occupies both a longitudinal row and a transverse row. In other examples of embodiments, the plurality of air cells 18 can be arranged in any geometry suitable for providing support to a user. For example, the air cells 18 can be arranged in a semi-circular pattern, a circular pattern, or any other suitable arrangement or geometry of air cells 18 to facilitate support for a user.

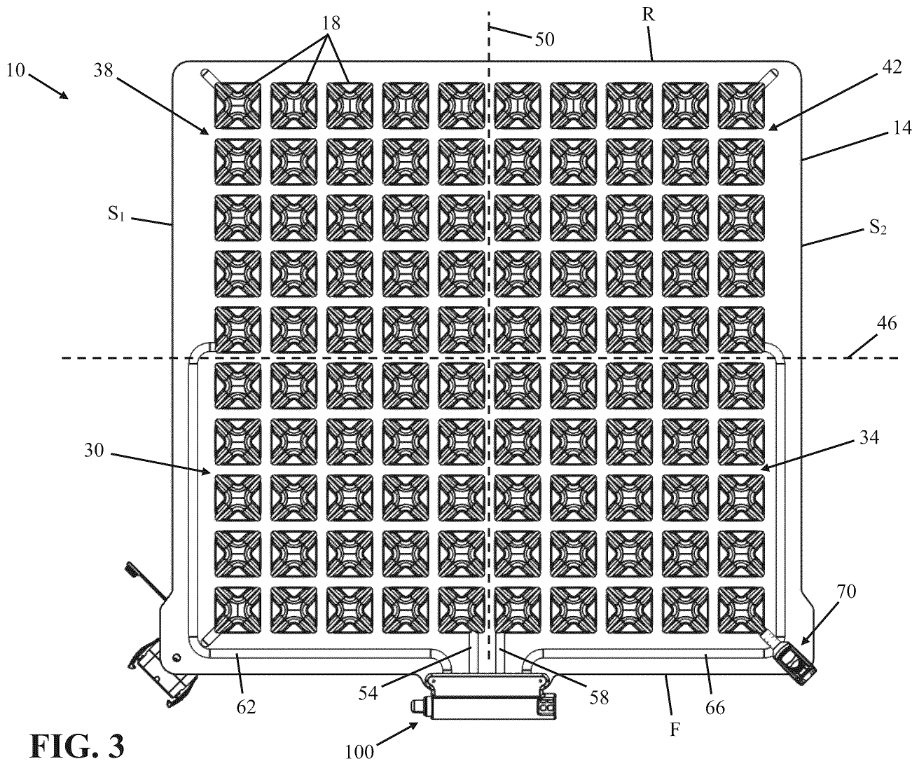

With reference now to FIG. 3, the cellular cushion 10 is arranged into a plurality of zones. More specifically, the air cells 18 of the cellular cushion 10 are arranged into a plurality of zones (also referred to as inflation zones or support zones). In the illustrated embodiment, the plurality of zones include four different inflation zones 30, 34, 38, 42. A first zone 30 is positioned adjacent to a second zone 34 along a first axis 46. Stated another way, the first and second zones 30, 34 are positioned side by side at a front F (or first end F) of the cellular cushion 10. A third zone 38 is positioned adjacent to a fourth zone 42 along the first axis 46. Stated another way, the third and fourth zones 38, 42 are positioned side by side at a rear R (or second end R) of the cellular cushion 10. In addition, the first zone 30 and the third zone 38 are positioned side by side along a second axis 50. Stated another way, the first and third zones 30, 38 are positioned side by side along a right side S₁ (or a first side S₁) of the cellular cushion 10. The second zone 34 and the fourth zone 42 are also positioned side by side along the second axis 50. Stated another way, the second and fourth zones 34, 42 are positioned side by side along a left side S₂ (or a second side S₂) of the cellular cushion 10. It should be appreciated that the sides (i.e., right and left sides) are described in relation to the user sitting on the cellular cushion 10. When describing the sides in relation to viewing the cellular cushion 10 from the front F to the rear R, the first side S₁ can be referred to as a left side, and the second side S₂ can be referred to as a right side. In the illustrated embodiment, the first axis 46 is generally perpendicular to (or generally orthogonal to) the second axis 50. In other embodiments of the cellular cushion 10, the zones 30, 34, 38, 42 of air cells 18 (shown in FIG. 1) can be oriented in any suitable orientation or geometry relative to each other. It should be appreciated that each of the plurality of zones 30, 34, 38, 42 is generally fluidly isolated from any other of the plurality of zones 30, 34, 38, 42. For example, during manufacturing, the upper and lower layers 22, 26 can be adhesively fastened along the imaginary first and second axes 46, 50 to define the plurality of fluidly isolated zones 30, 34, 38, 42. Thus, the air cells 18 positioned in each zone 30, 34, 38, 42 can be fluidly connected, but the air cells 18 positioned in each zone 30, 34, 38, 42 are fluidly isolated from air cells 18 in another zone 30, 34, 38, 42. Fluid connection between zones 30, 34, 38, 42 can only be facilitated by the multiport airflow control manifold assembly 100, which is discussed in further detail below.

The base 14 defines a plurality of fluid conduits 54, 58, 62, 66 (also referred to as an air conduit 54, 58, 62, 66). Each conduit 54, 58, 62, 66 fluidly connects each of the plurality of zones 30, 34, 38, 42 to a multiport airflow control manifold assembly 100. A first fluid conduit 54 fluidly connects the first zone 30 to the manifold assembly 100. A second fluid conduit 58 fluidly connects the second zone 34 to the manifold assembly 100. A third fluid conduit 62 fluidly connects the third zone 38 to the manifold assembly 100. A fourth fluid conduit 66 fluidly connects the fourth zone 42 to the manifold assembly 100. It should be appreciated that each conduit 54, 58, 62, 66 can be formed by molding, vacuum forming, or any other suitable process for formation between the upper and lower layers 22, 26 of the base 14 (shown in FIGS. 2 and 4).

An air valve 70 (also referred to as an inflation-deflation valve 70) is fluidly connected to the plurality of air cells 18. In the illustrated embodiment, the air valve 70 is fluidly connected to one of the air zones, and more specifically the second zone 34. In other examples of embodiments, the air valve 70 can be fluidly connected to the first zone 30, the third zone 38, or the fourth zone 42. The air valve 70 is configured to facilitate manual inflation and/or deflation of the plurality of air cells 18 (or inflation and deflation of the plurality of zones 30, 34, 38, 42). For example, the air valve 70 can be configured to engage an air pump (not shown) to facilitate inflation. The air pump can be a hand pump, a manual pump, a motorized pump, or any other suitable pump that is configured to supply air to the cellular cushion 10. The air pump (not shown) can provide a flow of air to one zone (for example, the second zone 34, the first zone 30, etc.). In the illustrated embodiment, air travels from the second zone 34 to the multiport airflow control manifold assembly 100 through the conduit 58. The air is then distributed to the other zones 30, 38, 42 through the respective conduits 54, 62, 66 by the manifold assembly 100. Similarly, the air valve 70 can be configured to deflate the plurality of cells 18 of the cellular cushion 10. The air valve 70 can be opened to the atmosphere, facilitating a release of air within the plurality of cells 18. More specifically, air can flow from the first, third, and fourth zones 30, 38, 42 to the second zone 34. The air flows through the respective conduits 54, 62, 66 to the manifold assembly 100, where it is directed through the conduit 58 to the second zone 34, and then discharged from the cellular cushion 10 through the air valve 70. It should be appreciated that the air valve 70 includes certain components and operates in a manner disclosed in U.S. Pat. No. 11,739,854, which is entitled “Valve Assembly for an Air Cushion” and assigned to Permobil, Inc., the entire contents of which is herein incorporated by reference in its entirety.

With reference now to FIGS. 3-4, the multiport airflow control manifold assembly 100 is configured to selectively fasten to the base 14. More specifically, the manifold assembly 100 is configured to fluidly engage each conduit 54, 58, 62, 66, while also fastening to the base 14. The manifold assembly 100 is also configured to fluidly connect to a remote air source. The remote air source is configured to supply airflow to each of the respective plurality of zones 30, 34, 38, 42.

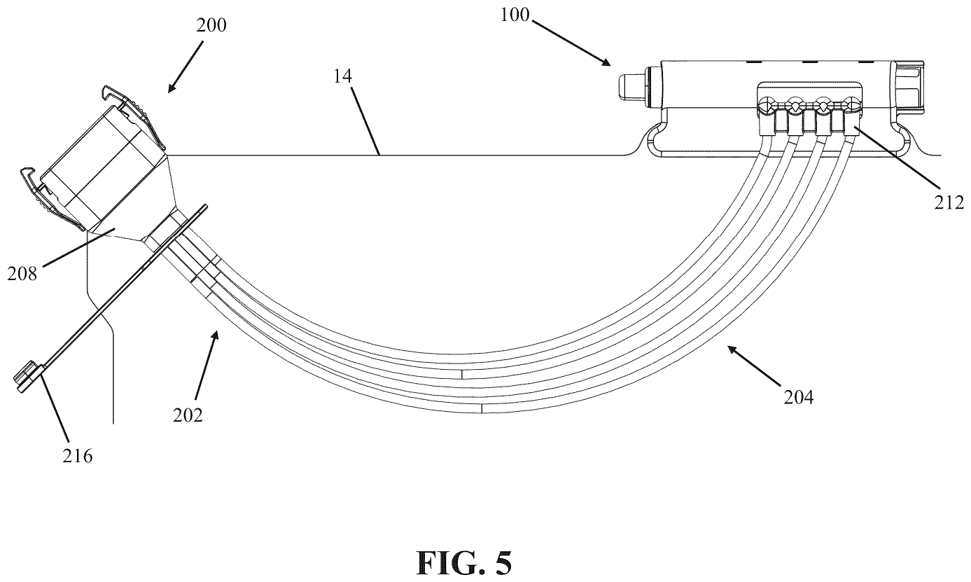

With reference now to FIGS. 4-5, an air supply assembly 200 is configured to attach to the multiport airflow control manifold assembly 100. The air supply assembly 200 is configured to connect the remote air source to the multiport airflow control manifold assembly 100. With specific reference to FIG. 5, a first portion 202 of the air supply assembly 200 is illustrated. The first portion 202 includes a plurality of air supply lines 204. The air supply lines 204 are each connected at a first end to a coupling member 208. The coupling member 208 is illustrated as a female coupling member 208. The air supply lines 204 are each connected at a second end, opposite the first end, to a manifold connector member 212. The connector member 212 is configured to attach each the plurality of air supply line 204 to the multiport airflow control manifold assembly 100. In the illustrated embodiment, the connector member 212 is a ninety degree (90°) adapter configured to engage the multiport airflow control manifold assembly 100. In this embodiment, one end of the connector member 212 is oriented orthogonal to the opposite end, such that the end in engagement with the multiport airflow control manifold assembly 100 is orthogonal (or perpendicular) to the opposite end in engagement with the plurality of air supply lines 204. In other examples of embodiments, the connector member 212 can be oriented in any suitable or desired orientation or angle. A clip member 216 can also be provided to selectively fasten (or clip) the first portion 202 of the air supply assembly 200 to the base 14. The clip member 216 can be provided to maintain a position of the first portion 202 relative to the base 14. It should be appreciated that in other examples of embodiments the coupling member 208 can be a male coupling member 208.

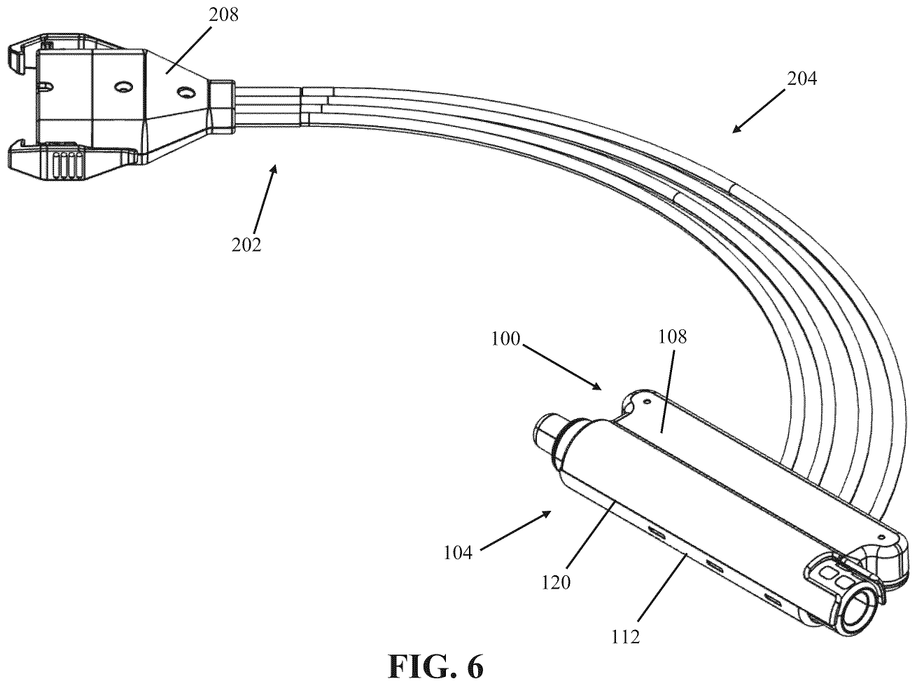

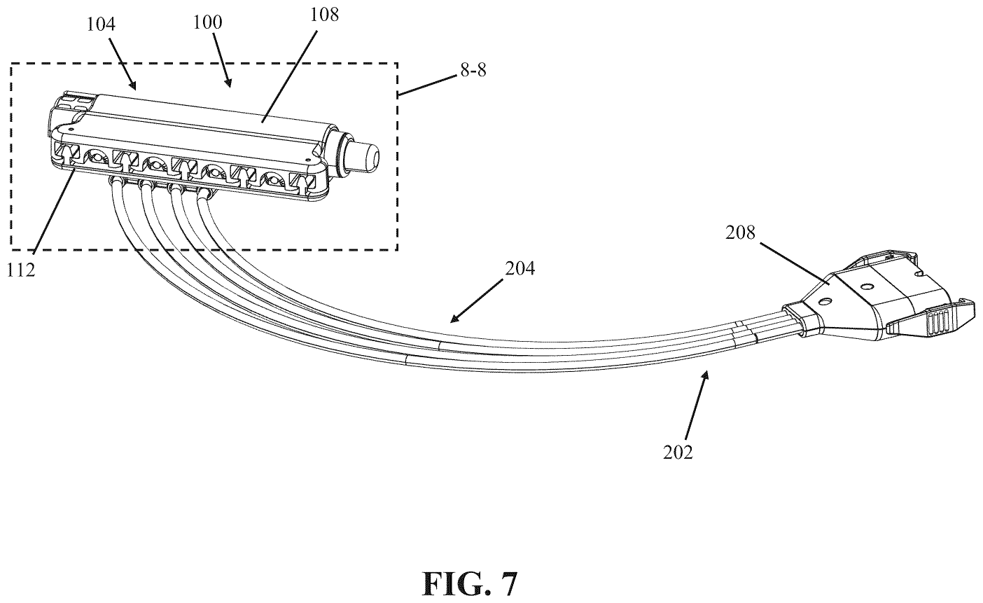

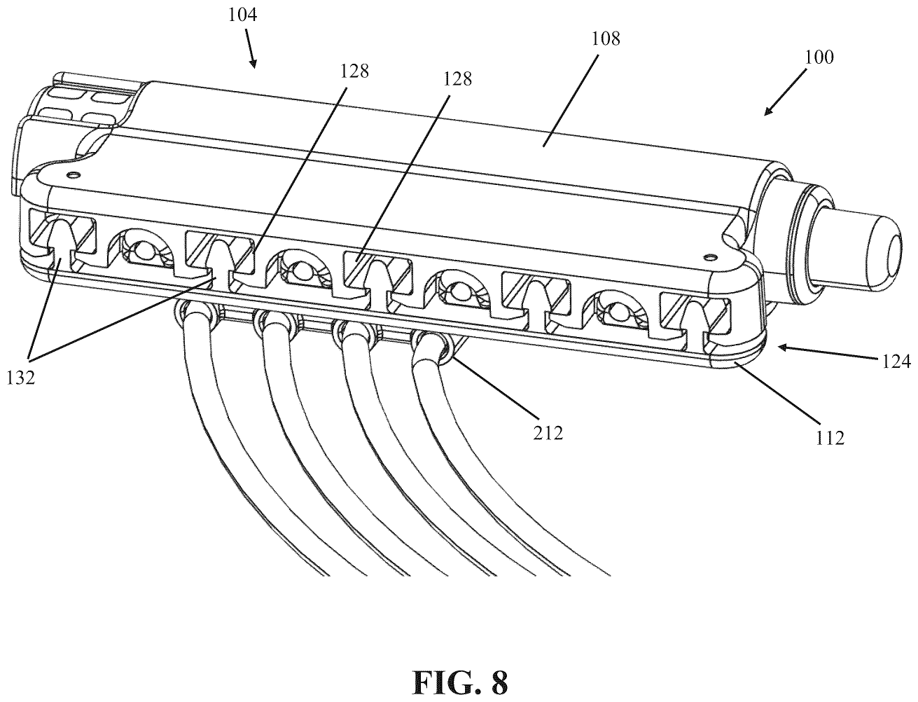

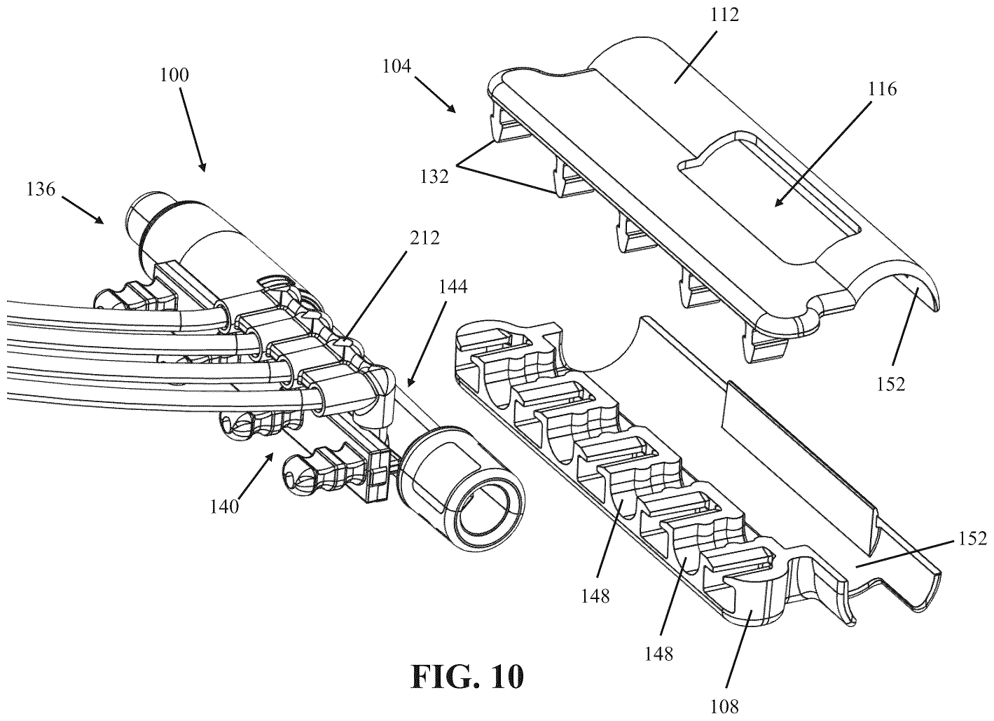

With reference now to FIGS. 6-8, the multiport airflow control manifold assembly 100 and the first portion 202 of the air supply assembly 200 are shown detached from the base 14 of the cellular cushion 10. The multiport airflow control manifold assembly 100 includes a housing assembly 104. The housing assembly 104 includes a first housing member 108 and a second housing member 112. The first housing member 108 (or upper housing member 108) is configured to be viewable (or exposed) to a user in response to fastening the multiport airflow control manifold assembly 100 to the cellular cushion 10. The second housing member 112 defines an aperture 116 (shown in FIG. 10). The aperture 116 is configured to receive the connector member 212. The first and second housing members 108, 112 are configured to self-fasten together. For example, the first and second housing members 108, 112 are configured to connect at a first end 120 (shown in FIG. 6). The connection between the first and second housing members 108, 112 can be formed by complimentary interlocking components or a living hinge. The first and second housing members 108, 112 are configured to self-fasten at a second end 124 (shown in FIG. 8). With reference to FIG. 8, the first housing member 108 can define a plurality of first fasteners 128, while the second housing member 112 can define plurality of second fasteners 132. Each first fastener 128 is configured to engage a second fastener 132 to fasten the first and second housing members 108, 112, and defining the self-fastening end 124 of the multiport airflow control manifold assembly 100. In the illustrated embodiment, the first fastener 128 is illustrated as an elongated channel, while the second fastener 132 is illustrated as a projection that is configured to be received and retained by the channel. In other examples of embodiments, any suitable fasteners 128, 132 can be used to fasten (or self-fasten) the housing members 108, 112 together. It should also be appreciated that the fastening end 124 is configured to engage and retain (or trap) a portion of the base 14 of the cellular cushion 10 between the housing members 108, 112. This facilitates fastening of the multiport airflow control manifold assembly 100 to the cellular cushion 10.

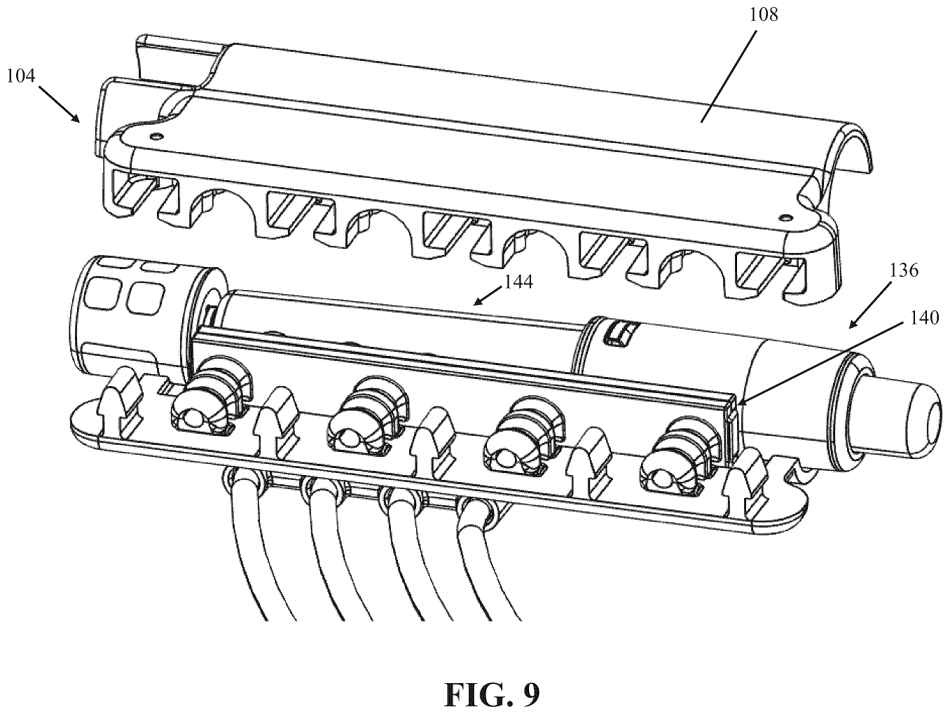

With reference now to FIGS. 9-10, the housing assembly 104 houses a valve assembly 136. The valve assembly 136 includes a manifold assembly 140 and an airflow control assembly 144. The housing assembly 104 is configured to receive and retain the valve assembly 136. In addition, the housing assembly 104 can include a geometry that is complimentary to the valve assembly 136 to receive and retain the valve assembly 136. For example, as shown in FIG. 10, the housing assembly 104 includes a first portion that defines a plurality of channels 148 (or recesses 148) that are configured to receive a portion of the manifold assembly 136. As another example, and also shown in FIG. 10, the housing assembly includes a second portion that defines an arcuate surface 152 that is configured to receive and retain the airflow control assembly 144. In other examples of embodiment, the housing assembly 104 can include any suitable geometry that is complimentary or suitable to the valve assembly 136 to restrict undesirable movement of the valve assembly 136 relative to the housing assembly 104, and further retain the valve assembly 136 in the housing assembly 104.

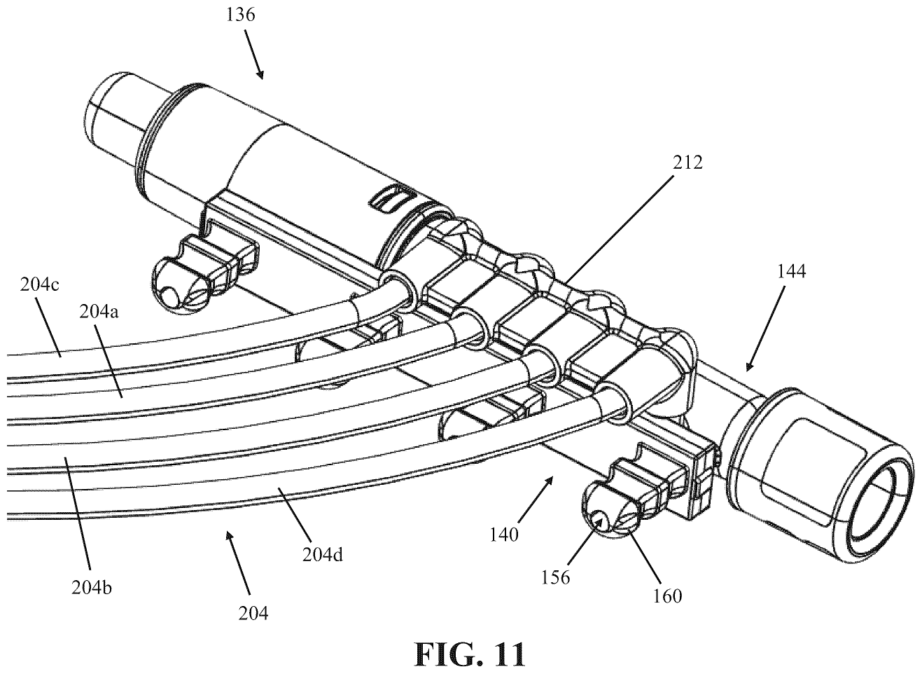

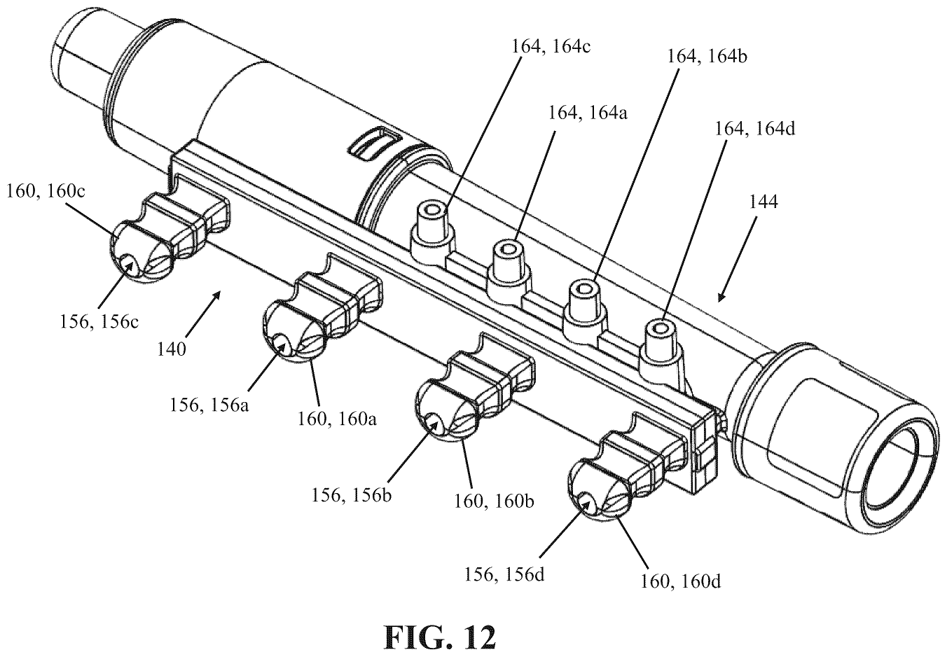

FIGS. 11-13 illustrate the valve assembly 136 removed from the housing assembly 104. The manifold assembly 140 includes at least one first air channel 156. With specific reference to FIG. 12, each air channel 156 is in fluid communication with a first port 160, a second port 164, and the airflow control assembly 144. In the illustrated embodiment, the manifold assembly 140 includes a plurality of air channels 156, and more specifically four air channels 156. In other examples of embodiment, the valve assembly 136 includes a number of air channels 156 that corresponds to the number of inflation zones 30, 34, 38, 42 of the cellular cushion 10. For example, the valve assembly 136 can include one air channel 156, two air channels 156, three air channels 156, four air channels 156, or five or more air channels 156.

With continued reference to FIG. 12, each air channel 156 is in fluid communication with one first port 160 and one second port 164. Each air channel 156 is also in fluid communication with the airflow control assembly 144. For each air channel 156, the first port 160 is downstream of the second port 164, and the second port 164 is downstream of the airflow control assembly 144. Stated another way, the second port 164 is fluidly connected to the air channel 156 upstream of the first port 160 and downstream of the airflow control assembly 144. Stated yet another way, both the first and second ports 160, 164 are in fluid communication with the air channel 156 downstream of the airflow control assembly 144, with the first port 160 being downstream of the second port 164.

With regard to the embodiment illustrated in FIG. 12, the manifold assembly 140 includes a first air channel 156a, a second air channel 156b, a third air channel 156c, and a fourth air channel 156d. The first air channel 156a is in fluid communication with a first first port 160a and a first second port 164a. The first air channel 156a is also in fluid communication with the airflow control assembly 144. The second air channel 156b is in fluid communication with a second first port 160b and a second second port 164b. The second air channel 156b is also in fluid communication with the airflow control assembly 144. The third air channel 156c is in fluid communication with a third first port 160c and a third second port 164c. The third air channel 156c is also in fluid communication with the airflow control assembly 144. The fourth air channel 156d is in fluid communication with a fourth first port 160d and a fourth second port 164d. The fourth air channel 156d is also in fluid communication with the airflow control assembly 144.

Each respective air channel 156a-d of the multiport airflow control manifold assembly 100 is in fluid communication with a respective inflation zone 30, 34, 38, 42 of the cellular cushion 10. To facilitate the fluid communication between the multiport airflow control manifold assembly 100 and each respective inflation zone 30, 34, 38, 42 of the cellular cushion 10, each first port 160 is configured to be in fluid communication with a respective inflation zone 30, 34, 38, 42 of the cellular cushion 10. In the illustrated embodiment, the first first port 160a is in fluid communication with the first zone 30 of the cellular cushion 10 (shown in FIG. 3). To facilitate the fluid communication, in the illustrated example, the first first port 160a is in fluid connection with the first fluid conduit 54. More specifically, the first fluid conduit 54 is configured to receive the first first port 160a.

The second first port 160b is in fluid communication with the second zone 34 of the cellular cushion 10 (shown in FIG. 3). To facilitate the fluid communication, in the illustrated example, the second first port 160b is in fluid connection with the second fluid conduit 58. More specifically, the second fluid conduit 58 is configured to receive the second first port 160b.

The third first port 160c is in fluid communication with the third zone 38 of the cellular cushion 10 (shown in FIG. 3). To facilitate the fluid communication, in the illustrated example, the third first port 160c is in fluid connection with the third fluid conduit 62. More specifically, the third fluid conduit 62 is configured to receive the third first port 160c.

The fourth first port 160d is in fluid communication with the fourth zone 42 of the cellular cushion 10 (shown in FIG. 3). To facilitate the fluid communication, in the illustrated example, the fourth first port 160d is in fluid connection with the fourth fluid conduit 66. More specifically, the fourth fluid conduit 66 is configured to receive the fourth first port 160d.

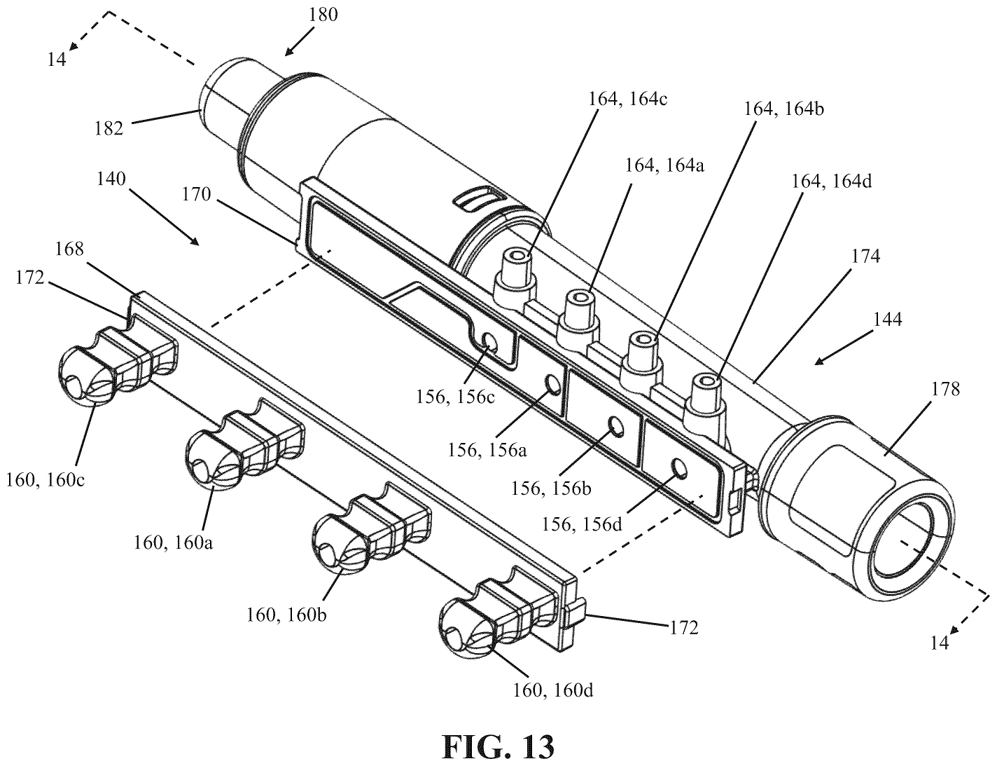

With reference to FIG. 13, the manifold assembly 140 can include a first manifold member 168 and a second manifold member 170. The first manifold member 168 includes the one or more first ports 160, while the second manifold member 170 includes the one or more second ports 164. The manifold members 168, 170 are configured to fasten together, for example by a fastener 172 positioned on each end of the first manifold member 168. The manifold members 168, 170 cooperate to define the air channels 156.

As discussed in additional detail below, a remote air source is in fluid communication with each second port 164 of the multiport airflow control manifold assembly 100. Accordingly, the remote air source, which is configured to selectively supply air and/or withdraw air, is in fluid communication with each respective air channel 156a-d. To facilitate the fluid communication between the remote air source and the multiport airflow control manifold assembly 100, the remote air source is fluidly connected to the multiport airflow control manifold assembly 100 by the air supply assembly 200. More specifically, the air supply lines 204 are configured to fluidly connect the remote air source to the multiport airflow control manifold assembly 100. With reference back to FIG. 11, a plurality of the air supply lines 204 are connected to the connector member 212, which is in turn connected to each of the second ports 164 (shown in FIG. 12). In the illustrated example of embodiment, a first air supply line 204a is fluidly connected to the first second port 164a, a second air supply line 204b is fluidly connected to the second second port 164b, a third air supply line 204c is fluidly connected to the third second port 164c, and a fourth air supply line 204d is fluidly connected to the fourth second port 164d. In the illustrated embodiment, the connector member 212 connects each air supply line 204a-d to the respective second port 164a-d. However, in other embodiments, each air supply line 204a-d can be connected to each respective second port 164a-d by an individual connector member.

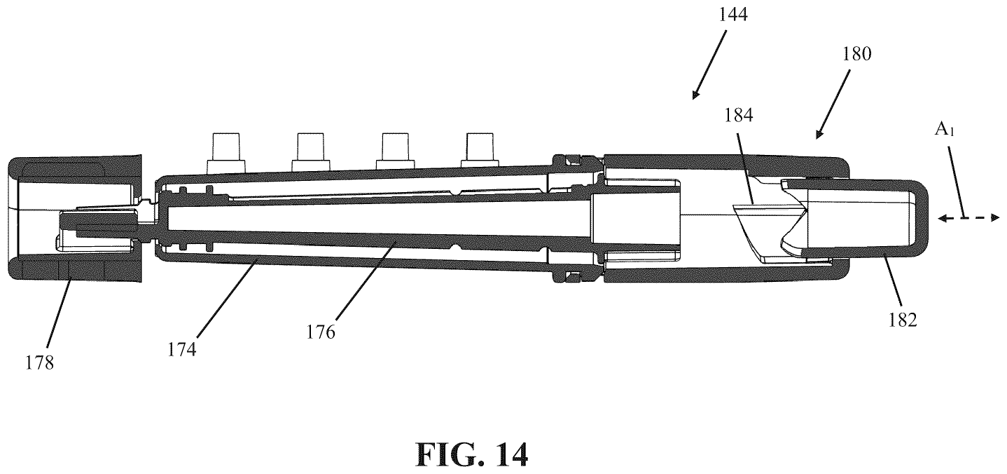

With continued reference to FIG. 13, the airflow control assembly 144 is fluidly connected to each of the air channels 156. The airflow control assembly 144 is configured to selectively connect and/or selectively isolate one or more of the air channels 156. The airflow control assembly 144 includes a valve body 174. The valve body 174 houses a seal member 176 (see FIG. 14). The seal member 176 is configured to move relative to the valve body 174. As a nonlimiting example, the seal member 176 is configured to rotate relative to the valve body 174. An indicator member 178 is coupled to the seal member 176. The indicator member 178 is configured to rotate with the seal member 176. An actuation assembly 180 is operatively connected to the seal member 176. The actuation assembly 180 is configured to facilitate selective rotation of the seal member 176 relative to the valve body 174. The actuation assembly 180 can include an actuation member 182. As shown in FIG. 14, in the illustrated embodiment, the actuation member 182 is a depressible button 182 that includes an angled projection 184. The projection 184 is configured to selectively engage a cam member (not shown) coupled to the seal member 176. By depressing the button 182 along a first axis A₁ towards the seal member 176, the button 182 and angled projection 184 translate along the first axis A₁ into engagement with the cam member (not shown). This results in rotation of the seal member 176 relative to the valve body 174. In other examples of embodiments, the actuation member 182 can be configured to rotate relative to the valve body 174 to facilitate rotation of the seal member 176.

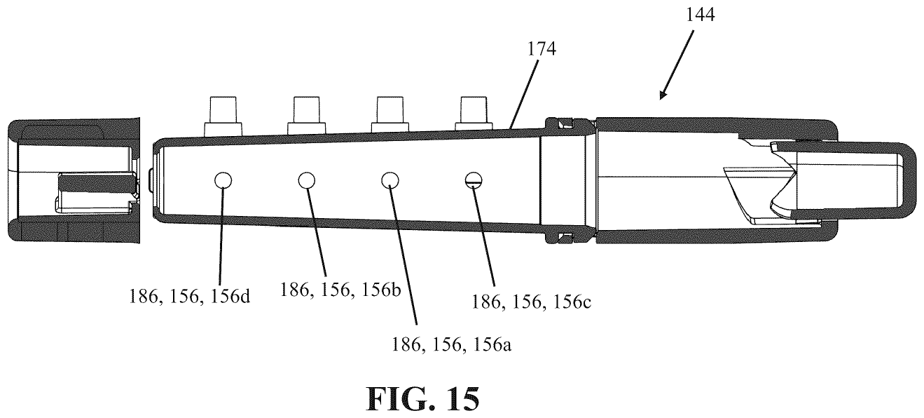

With reference to FIG. 15, the valve body 174 defines a plurality of apertures 186. Each aperture is associated with an associated air channel 156 to fluidly connect each air channel 156a-d to the valve body 174.

The seal member 176 includes a plurality of seals that are arranged in different seal configurations. Movement of the seal member 176 relative to the valve body 174 is configured to align the seals of each seal configuration with the apertures 186. In a first seal configuration (or a first position), the seals are arranged into a plurality of separate compartments. In the illustrated example of the multiport airflow control manifold assembly 100, the seals are divided into four fluidly separate compartments. Each compartment is separated from an adjacent compartment by a circumferential radial divider. The first seal configuration is also separated from an adjacent seal configuration by a pair of elongated radial dividers extending along a length of the seal member. As such, the elongated radial dividers separate each seal configuration. In the first seal configuration, each compartment is isolated from an adjacent compartment. In turn, air cannot flow between compartments. When oriented within the valve body 174 into fluid communication with the air channels 156a-d, the first seal configuration results in each of the fluid conduits 54, 58, 62, 66 and associated inflation zones 30, 34, 38, 42 being fluidly isolated from each other. As such, air cannot travel between the inflation zones 30, 34, 38, 42 via the seal member 176 in response to the first seal configuration.

In a second seal configuration (or second position), the seals are divided into a single compartment. The second seal configuration is separated from an adjacent seal configuration by a pair of elongated radial dividers extending along the length of the seal member 176. In the second seal configuration, the single compartment facilitates a flow of air within the compartment. When oriented within the valve body 174 into fluid communication with the air channels 156a-d, the second seal configuration results in each of the fluid conduits 54, 58, 62, 66 and associated inflation zones 30, 34, 38, 42 being fluidly connected to each other. As such, air is free to travel between the inflation zones 30, 34, 38, 42 via the seal member 176 in response to the second seal configuration.

In a third seal configuration (or a third position), the seals are divided into a pair of separated compartments. More specifically, the seals are divided into two fluidly separate compartments. The compartments are separated from the adjacent compartment by a single circumferential radial divider. The third seal configuration is also separated from an adjacent seal configuration by a pair of elongated radial dividers extending along a length of the seal member 176. As such, the elongated radial dividers separate each seal configuration. In the third seal configuration, each of the two compartments are fluidly isolated. Thus, air cannot flow between the compartments. When oriented within the valve body 174 into fluid communication with the air channels 156a-d, the third seal configuration results in two fluid conduits being fluidly connected. Stated another way, the third seal configuration results in a first group of inflation zones 30, 38 and a second group of inflation zones 34, 42. The first group of inflation zones, which in the present embodiment is a first pair of inflation zones 30, 38, are fluidly connected. The second group of inflation zones, which in the present embodiment is a second pair of inflation zones 34, 42, are also fluidly connected. Air is configured to flow between the first pair of inflation zones 30, 38. Similarly, air is configured to flow between the second pair of inflation zones 34, 42. However, air is restricted from flowing from the first pair of inflation zones to the second pair of inflation zones, and vice versa. In the illustrated embodiment, the first pair of inflation zones correspond to the first side S₁, and the second pair of inflation zones correspond to the second side S₂ of the cellular cushion 10. It should be appreciated that in other examples of embodiments, the third seal configuration can be reoriented with the associated fluid conduits 54, 58, 62, 66 such that the third seal configuration results in the first pair of inflation zones corresponding to the front F inflation zones 30, 34, and the second pair of inflation zones correspond to the rear R inflation zones 38, 42. It should also be appreciated that the first group of inflation zones can be referred to as a first group of connectors, and the second group of inflation zones can be referred to as a second group of connectors. It should also be appreciated that while the first group of connectors are fluidly connected, and the second group of connectors are fluidly connected, the first and second group of connectors are fluidly isolated from each other.

As the seal member 176 moves relative to the valve body 174 between seal configurations, the indicator member 178 moves with the seal member 176. As a nonlimiting example, as the seal member 176 rotates relative to the valve body 174 between seal configurations, the indicator member 178 rotates with the seal member 176. The indicator member 178 includes a plurality of indicia, with each indicia associated with the selected seal configuration. For example, the indicia can be a respective identification, color, symbol, or any other suitable information to convey to a user the selected seal configuration.

It should be appreciated that the airflow control assembly 144 includes certain components and operates in a manner disclosed in U.S. Pat. No. 11,801,175, which is entitled “Multi-Position Airflow Control Assembly for an Air Cushion” and assigned to Permobil, Inc., the entire contents of which is herein incorporated by reference in its entirety.

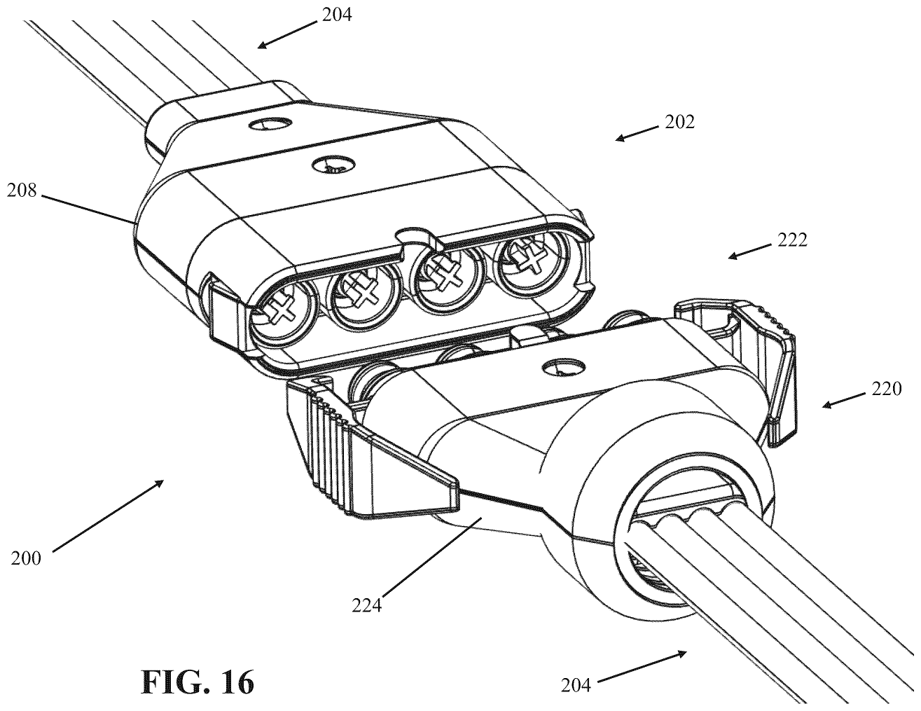

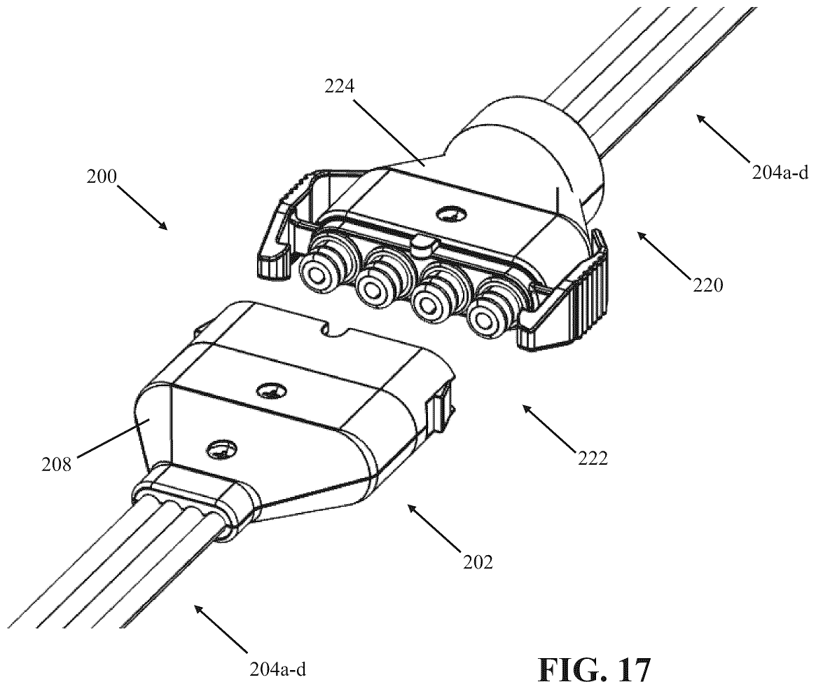

With reference now to FIGS. 16-17, the first portion 202 and a second portion 220 of the air supply assembly 200 are illustrated. The first portion 202 includes the plurality of air supply lines 204a-d. The second portion 220 also includes a plurality of air supply lines 204a-d. The first and second portions 202, 220 are configured to selectively fasten together by a coupling assembly 222. The coupling assembly includes a first coupling member 208 (shown as the male coupling member 208) and a second coupling member 224 (shown as a female coupling member 224). The male coupling member 208 includes a plurality of first ports, with each port associated with one of the air supply lines 204 of the first portion 202. To block air loss in a disconnected configuration, each port of the male coupling member 208 has a valve that is biased to a closed position. The female coupling member 224 includes a plurality of second ports, with each port also associated with one of the air supply lines 204 of the second portion 220. In response to the female coupling member 224 being positioned into engagement with the male coupling member 208, the male coupling member 208 is configured to be received by the female coupling member 224. More specifically, each first port of the coupling member 208 is configured to receive an associated second port of the coupling member 224. Once received, each second port laterally slides the valve associated with each first port, overcoming the applied bias and fluidly connecting the air supply lines 204 of each portion 202, 220. The coupling members 208, 224 are further configured to removably fasten together to facilitate the fluid connection. The coupling member 208, 224 can also be selectively disengaged. Once disengaged (or unfastened) the male coupling member 208 is removed from the female coupling member 224. In response to disengagement of the second ports from the first ports, the associated bias is reapplied to the valve of each first port, closing the first ports to limit air loss. It should be appreciated that in other examples of embodiments, the first portion 202 can include the female coupling member 224, while the second portion 220 can include the male coupling member 208. Stated another way, the male and female coupling members 208, 224 can be associated with either the first or second portions 202, 220. In addition, it should be appreciated that the coupling assembly 222 can include any suitable system for selectively attaching and detaching the air supply lines 204 to facilitate air flow in a connected configuration and restrict airflow from escaping the cellular cushion 10 in a disconnected configuration.

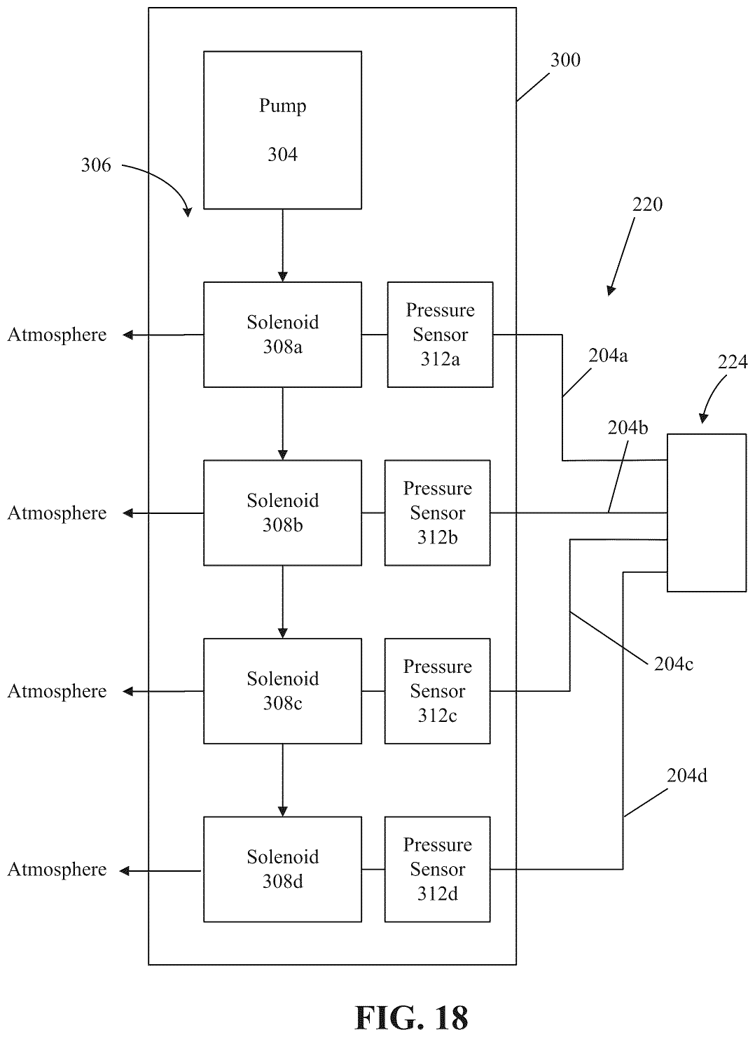

FIG. 18 is a schematic diagram of an example of an embodiment of a remote air source assembly 300 (also referred to as an air source assembly 300). The remote air source assembly 300 is configured to selectively connect to the multiport airflow control manifold assembly 100, and in turn the cellular cushion 10, by the air supply assembly 200. FIG. 18 illustrates the second portion 220 of the air support assembly 200 (shown in FIGS. 16-17).

The remote air source assembly 300 includes a pump 304 (also referred to as an air pump 304) that is operably and fluidly connected to a valve array 306. The valve array 306 includes a plurality of valves 308, which are each illustrated as solenoid valves 308. The valves 308 of the valve array 306 are configured to selectively open to facilitate air flow from the pump 304 through the valve 308 to the associated air supply line 204 to facilitate inflation of each respective inflation zone 30, 34, 38, 42 of the cellular cushion 10. The valves 308 of the valve array 306 can also be configured to selectively open to facilitate air flow from each associated air supply line 204 to atmosphere to facilitate deflation of each respective inflation zone 30, 34, 38, 42 of the cellular cushion 10. A pressure sensor 312 can also be positioned downstream of each valve 308 to detect a pressure in the associated inflation zone 30, 34, 38, 42 of the cellular cushion 10. The remote air source assembly 300 can also include a controller (not shown) to facilitate operation of the pump 304 and valve array 306, and to receive detected pressure readings from each pressure sensor 312. The remote air source assembly 300 can further include a power source (not shown) such as a rechargeable battery or other suitable power source to operate the pump 304, valve array 306, pressure sensors 312, controller, and other associated components.

In operation, the multiport airflow control manifold assembly 100 is configured to facilitate inflation and/or deflation of the associated inflation zones 30, 34, 38, 42 of the cellular cushion 10. To facilitate inflation, the pump 304 of the remote air source assembly 300 can operate. Depending on the inflation zone 30, 34, 38, 42 of the cellular cushion 10 that requires inflation, the associated valve 308 of the valve array 306 can be opened to facilitate airflow from the remote air source assembly 300 to the associated inflation zone 30, 34, 38, 42 of the cellular cushion 10.

For example, to facilitate inflation of the first inflation zone 30, the pump 304 is operational and a first valve 308a actuates to an open configuration. Air flow from the pump 304 travels through the first valve 308a, exiting the remote air source assembly 300 and traveling through the first air supply line 204a. The air flow then enters the first second port 164a of the manifold assembly 140. The air flow travels from the first second port 164a to the first air channel 156a, where the air flow exits the manifold assembly 140 through the first first port 160a. The air flow is then directed to the first inflation zone 30 through the first fluid conduit 54 of the cellular cushion 10. Once a desired inflation level is achieved, the remote air source assembly 300 closes the associated first valve 308a to terminate air flow to the first inflation zone 30.

To facilitate inflation of the second inflation zone 34, the pump 304 is operational and a second valve 308b actuates to an open configuration. Air flow from the pump 304 travels through the second valve 308b, exiting the remote air source assembly 300 and traveling through the second air supply line 204b. The air flow then enters the second second port 164b of the manifold assembly 140. The air flow travels from the second second port 164b to the second air channel 156b, where the air flow exits the manifold assembly 140 through the second first port 160b. The air flow is then directed to the second inflation zone 34 through the second fluid conduit 58 of the cellular cushion 10. Once a desired inflation level is achieved, the remote air source assembly 300 closes the associated second valve 308b to terminate air flow to the second inflation zone 34.

To facilitate inflation of the third inflation zone 38, the pump 304 is operational and a third valve 308c actuates to an open configuration. Air flow from the pump 304 travels through the third valve 308c, exiting the remote air source assembly 300 and traveling through the third air supply line 204c. The air flow then enters the third second port 164c of the manifold assembly 140. The air flow travels from the third second port 164c to the third air channel 156c, where the air flow exits the manifold assembly 140 through the third first port 160c. The air flow is then directed to the third inflation zone 38 through the third fluid conduit 62 of the cellular cushion 10. Once a desired inflation level is achieved, the remote air source assembly 300 closes the associated third valve 308c to terminate air flow to the third inflation zone 38.

To facilitate inflation of the fourth inflation zone 42, the pump 304 is operational and a fourth valve 308d actuates to an open configuration. Air flow from the pump 304 travels through the fourth valve 308d, exiting the remote air source assembly 300 and traveling through the fourth air supply line 204d. The air flow then enters the fourth second port 164d of the manifold assembly 140. The air flow travels from the fourth second port 164d to the fourth air channel 156d, where the air flow exits the manifold assembly 140 through the fourth first port 160d. The air flow is then directed to the fourth inflation zone 42 through the fourth fluid conduit 62 of the cellular cushion 10. Once a desired inflation level is achieved, the remote air source assembly 300 closes the associated fourth valve 308d to terminate air flow to the fourth inflation zone 42.

Once each inflation zone 30, 34, 38, 42 is inflated to a desired inflation level, the multiport airflow control manifold assembly 100 can facilitate maintaining of a desired (or target) inflation level. For example, each pressure sensor 312a, 312b, 312c, 312d is configured to measure a pressure in an associated inflation zone 30, 34, 38, 42 of the cellular cushion 10. For example, a first pressure sensor 312a detects a pressure in the first inflation zone 30, a second pressure sensor 312b detects a pressure in the second inflation zone 34, a third pressure sensor 312c detects a pressure in the third inflation zone 38, and a fourth pressure sensor 312d detects a pressure in the fourth inflation zone 42. In response to a detected pressure dropping below a desired pressure, the remote air source assembly 300 can initiate operation of the pump 304 and then open the associated valve 308a-d to reinflate the associated inflation zone 30, 34, 38, 42. Once a desired pressure is achieved, the remote air source assembly 300 can close the associated valve 308a-d, and when all valves 308a-d are closed, can terminate operation of the pump 304.

Should an inflation zone 30, 34, 38, 42 be overinflated, or a target pressure reduced for one or more inflation zones 30, 34, 38, 42, the remote air source assembly 300 can also facilitate deflation of one or more inflation zones 30, 34, 38, 42. For example, in response to a detected pressure being above a desired pressure, or a target desired pressure being reduced, for one or more inflation zones 30, 34, 38, 42, the remote air source assembly 300 can open the associated valve 308a-d to discharge to atmosphere. Air from the associated inflation zone 30, 34, 38, 42 can travel from the associated inflation zone 30, 34, 38, 42, through the associated fluid conduit 54, 58, 62, 66, into the associated air channel 156a-d from the associated first port 160a-d, out of the associated air channel 156a-d from the associated second port 164a-d, through the associated air supply line 204a-d, and then through the associated valve 308a-d to be discharged to atmosphere. Once an inflation zone 30, 34, 38, 42 is deflated to a desired pressure, the remote air source assembly 300 can close the associated valve 308a-d. It should be appreciated that alternatively, a user can deflate the inflation zones 30, 34, 38, 42 through the air valve 70. Once an amount of air is discharged, the inflation zones 30, 34, 38, 42 can reach a level of equilibrium, the remote air source assembly 300 can measure and control the inflation level of the inflation zones 30, 34, 38, 42 relative to the desired pressure.

In addition to being configured to facilitate inflation and/or deflation of the associated inflation zones 30, 34, 38, 42 of the cellular cushion 10, the multiport airflow control manifold assembly 100 is configured to selectively connect and/or selectively isolate one or more of the inflation zones 30, 34, 38, 42. For example, actuation of the airflow control assembly 144 to the first seal configuration results in fluidly isolating all of the inflation zones 30, 34, 38, 42. Air cannot travel within the seal member 176 between air channels 156a-d. Stated another way, each air channel 156a-d is fluidly isolated from all of the other air channels 156a-d. Air can only travel through each respective air channel 156a-d of the manifold assembly, entering and exiting the associated first and second ports 160a-d, 164a-d.

Actuation of the airflow control assembly 144 to the second seal configuration results in fluidly connecting all of the inflation zones 30, 34, 38, 42. Air can travel within the seal member 176 between all of the air channels 156a-d. Stated another way, all of the air channels 156a-d are fluidly connected to each other by the seal member 176. Air can not only travel through each respective air channel 156a-d of the manifold assembly, entering and exiting the associated first and second ports 160a-d, 164a-d, but air also connects all of the air channels 156a-d together within the seal member 176.

Actuation of the airflow control assembly 144 to the third seal configuration results in fluidly connecting groups of inflation zones 30, 34, 38, 42. In one example, in the third seal configuration, the seal member connects the first group of inflation zones 30, 38 and the second group of inflation zones 34, 42. In this configuration, the first and third air channels 156a, 156c are fluidly connected within the seal member 176. As such, air can travel between the first and third air channels 156a, 156c in the seal member 176. In addition, the second and fourth air channels 156b, 156d are fluidly connected within the seal member 176. As such, air can travel between the second and fourth air channels 156b, 156d in the seal member 176. Stated another way, air in the first group of inflation zones 30, 38 can enter and exit through each air channel 156a, 156c through the associated first ports 160a, 160c and second ports 164a, 164c, and further air can travel between the first and third air channels 156a, 156c within the seal member 176. Air in the second group of inflation zones 34, 42 can enter and exit through each air channel 156b, 156d through the associated first ports 160b, 160d and second ports 164b, 164d, and further air can travel between the second and fourth air channels 156b, 156d within the seal member 176.

In another example, in the third seal configuration, the seal member connects the first group of inflation zones 30, 34 and the second group of inflation zones 38, 42. In this configuration, the first and second air channels 156a, 156b are fluidly connected within the seal member 176. As such, air can travel between the first and second air channels 156a, 156b in the seal member 176. In addition, the third and fourth air channels 156c, 156d are fluidly connected within the seal member 176. As such, air can travel between the third and fourth air channels 156c, 156d in the seal member 176. Stated another way, air in the first group of inflation zones 30, 34 can enter and exit through each air channel 156a, 156b through the associated first ports 160a, 160b and second ports 164a, 164b, and further air can travel between the first and second air channels 156a, 156b within the seal member 176. Air in the second group of inflation zones 38, 42 can enter and exit through each air channel 156c, 156d through the associated first ports 160c, 160d and second ports 164c, 164d, and further air can travel between the third and fourth air channels 156c, 156d within the seal member 176. It should be appreciated that in some examples of embodiments, the alternative third seal configuration (grouping zones 30, 34 and 38, 42) can be a fourth seal configuration. It should also be appreciated that any suitable grouping of one or more zones can be achieved, and further the zones can be grouped in uneven numbers. For example, in an example of an embodiment of a cushion with three zones, a first group can include one zone 30 (or a pair of zones 30, 34) and a second group can include a pair of zones 34, 38 (or one zone 38).

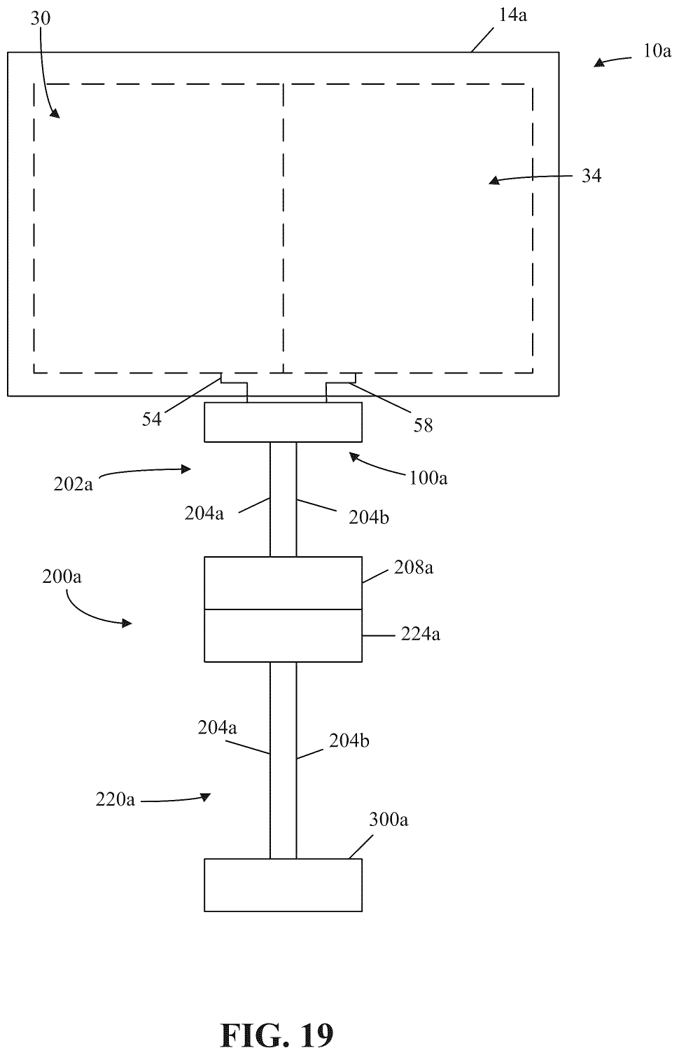

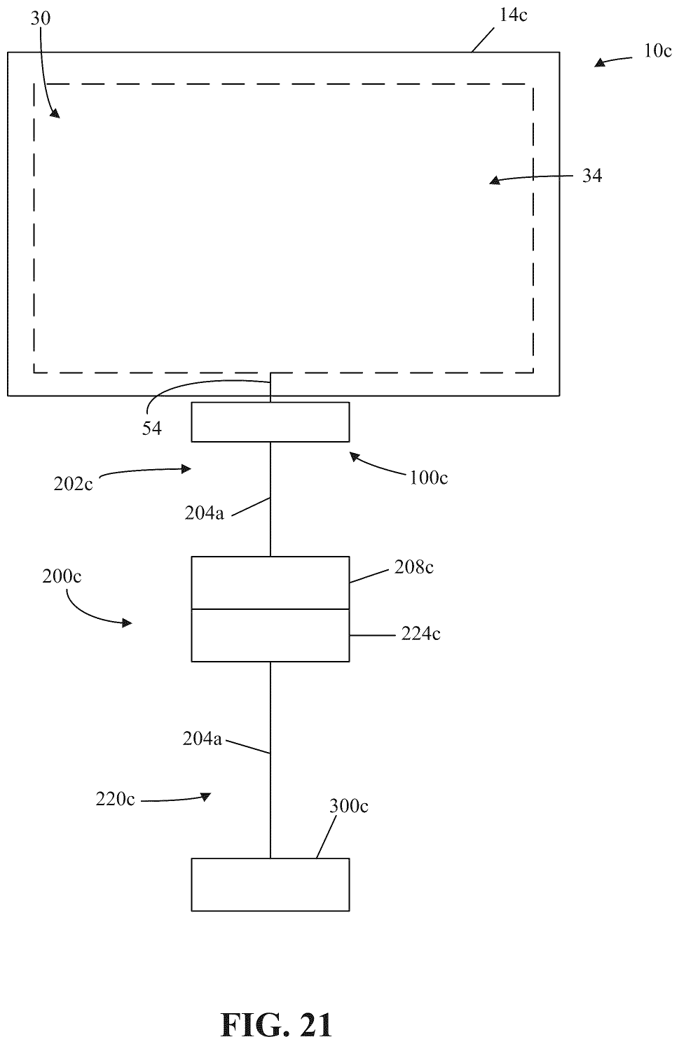

FIGS. 1-18 disclose an embodiment of a cellular cushion 10 that includes four inflation zones 30, 34, 38, 42. Accordingly, the associated multiport airflow control manifold assembly 100 includes four air channels 156a-d, the air supply assembly 200 includes four air supply lines 204, and the remote air source assembly 300 includes a valve array 306 that includes four valves 308. It should be appreciated that this is one example of an embodiment, and the multiport airflow control manifold assembly 100 and associated components can easily be adapted for use with a cellular cushion 10 having fewer or more than fourth inflation zones 30, 34, 38, 42. FIGS. 19-21 illustrate non-limiting alternative examples. It should be appreciated that FIGS. 19-21 use similar identification numbers to identify similar components.

With reference to FIG. 19, an embodiment of the cellular cushion 10a is illustrated having two inflation zones 30, 34. Since this embodiment of the cellular cushion 10a includes only two inflation zones 30, 34, the multiport airflow control manifold assembly 100a is modified to include two air channels 156 (not shown). As such, the air supply assembly 200a is modified to have two air supply lines 204a, 204b fluidly connecting the remote air source assembly 300a to the multiport airflow control manifold assembly 100a. In addition, the first and second coupling members 208a, 224a are modified to each have two ports to facilitate connection of the portions of the two air supply lines 204a, 204b. The remote air source assembly 300a also includes a valve array 306 (not shown) that includes two valves 308 (not shown), one associated with each air supply line 204a, 204b. The components otherwise operate as described in association with the cellular cushion 10 and the multiport airflow control manifold assembly 100.

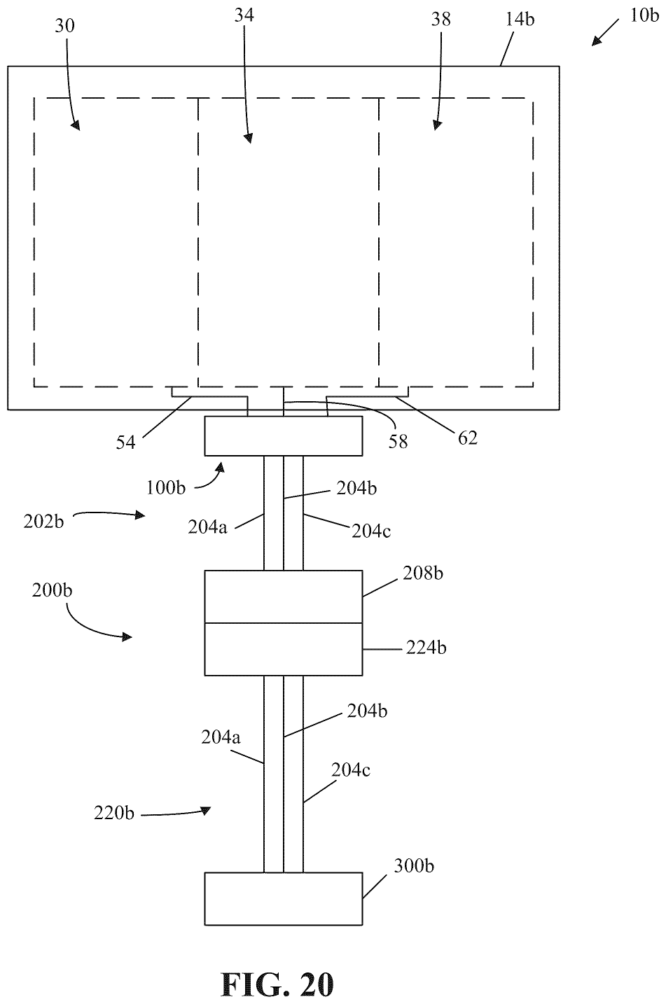

With reference to FIG. 20, an embodiment of the cellular cushion 10b is illustrated having three inflation zones 30, 34, 38. Since this embodiment of the cellular cushion 10b includes only three inflation zones 30, 34, 38, the multiport airflow control manifold assembly 100b is modified to include three air channels 156 (not shown). As such, the air supply assembly 200b is modified to have three air supply lines 204a, 204b, 204c fluidly connecting the remote air source assembly 300b to the multiport airflow control manifold assembly 100b. In addition, the first and second coupling members 208b, 224b are modified to each have three ports to facilitate connection of the portions of the three air supply lines 204a, 204b, 204c. The remote air source assembly 300b also includes a valve array 306 (not shown) that includes three valves 308 (not shown), one associated with each air supply line 204a, 204b, 204c. The components otherwise operate as described in association with the cellular cushion 10 and the multiport airflow control manifold assembly 100.

With reference to FIG. 20, an embodiment of the cellular cushion 10c is illustrated having a single inflation zone 30. Since this embodiment of the cellular cushion 10c includes only one inflation zone 30, the multiport airflow control manifold assembly 100c is modified to include one air channel 156 (not shown). In addition, the multiport airflow control manifold assembly 100c is arranged to eliminate the airflow control assembly 144. The air supply assembly 200c is modified to have one air supply line 204a fluidly connecting the remote air source assembly 300c to the multiport airflow control manifold assembly 100c. In addition, the first and second coupling members 208c, 224c are modified to each have one port to facilitate connection of the portions of the air supply line 204a. The remote air source assembly 300c also includes a valve array 306 (not shown) that includes one valve 308 (not shown) associated with the air supply line 204a. The components otherwise operate as described in association with the cellular cushion 10 and the multiport airflow control manifold assembly 100.

One or more aspects of the multiport airflow control manifold assembly 100 provides certain advantages outlined above. These and other advantages are realized by the disclosure provided herein.

What is claimed is:

1. A multiport airflow control manifold assembly comprising:
a valve assembly including:
a manifold assembly defining a first air channel, a second air channel, and a third air channel;
a first first port fluidly connected to first air channel;
a first second port fluidly connected to the first air channel;
a second first port fluidly connected to second air channel;
a second second port fluidly connected to the second air channel;
a third first port fluidly connected to third air channel;
a third second port fluidly connected to the third air channel; and
an airflow control assembly fluidly connected to the manifold assembly, the airflow control assembly including a seal member configured to move between a first seal configuration and a second seal configuration,
wherein in the first seal configuration, the seal member is configured to fluidly isolate the first air channel, the second air channel, and the third air channel, and
wherein in the second seal configuration, the seal member is configured to fluidly connect the first air channel, the second air channel, and the third air channel.

2. The multiport airflow control manifold assembly of claim 1, wherein the first second port is fluidly connected to the first air channel downstream of the seal member and upstream of the first first port.

3. The multiport airflow control manifold assembly of claim 1, wherein the second second port is fluidly connected to the second air channel downstream of the seal member and upstream of the second first port.

4. The multiport airflow control manifold assembly of claim 1, wherein the third second port is fluidly connected to the third air channel downstream of the seal member and upstream of the third first port.

5. The multiport airflow control manifold assembly of claim 1, wherein the seal member is configured to move to a third seal configuration, wherein in the third seal configuration, the seal member is configured to fluidly isolate the first air channel, and fluidly connect the second air channel and the third air channel.

6. The multiport airflow control manifold assembly of claim 1, wherein the first second port, the second second port, and the third second port are configured to be fluidly connected to an air source assembly, the air source assembly is configured to provide a flow of air to the manifold assembly.

7. The multiport airflow control manifold assembly of claim 6, wherein the first first port is configured to be fluidly connected to a first inflation zone of a cellular cushion, the second first port is configured to be fluidly connected to a second inflation zone of the cellular cushion, and the third first port is configured to be fluidly connected to a third inflation zone of the cellular cushion.

8. The multiport airflow control manifold assembly of claim 6, wherein the air source assembly includes a pump, the pump is configured to provide the flow of air.

9. The multiport airflow control manifold assembly of claim 6, wherein the air source assembly is fluidly connected to the first second port, the second second port, and the third second port by an air supply assembly.

10. The multiport airflow control manifold assembly of claim 9, wherein the air supply assembly includes a first air supply line fluidly connecting the air source assembly to the first second port, a second air supply line fluidly connecting the air source assembly to the second second port, and a third air supply line fluidly connecting the air source assembly to the third second port.

11. The multiport airflow control manifold assembly of claim 10, wherein the air supply assembly includes a coupling assembly defining a first coupling member and a second coupling member, the first coupling member configured to removably connect to the second coupling member to fluidly connect the first, second, and third air supply lines between the air supply assembly and the manifold assembly.

12. The multiport airflow control manifold assembly of claim 11, wherein in response to disconnecting the first coupling member and the second coupling member, the first, second, and third air supply lines are fluidly disconnected between the air supply assembly and the manifold assembly.

13. The multiport airflow control manifold assembly of claim 1, wherein the airflow control assembly includes a valve body, the seal member is received by the valve body.

14. The multiport airflow control manifold assembly of claim 13, wherein the seal member is configured to rotate relative to the valve body between seal configurations.

15. The multiport airflow control manifold assembly of claim 13, wherein the valve body defines a plurality of apertures, each aperture fluidly connects the first air channel, the second air channel, and the third air channel to the seal member.

16. A multiport airflow control manifold assembly configured to connect an air supply assembly to a cellular cushion, the manifold assembly comprising:
a manifold assembly defining a first air channel, a second air channel, and a third air channel;
a first first port and a first second port fluidly connected to the first air channel;
a second first port and a second second port fluidly connected to the second air channel;
a third first port and a third second port fluidly connected to the third air channel;
an airflow control assembly fluidly connected to the manifold assembly, the airflow control assembly including a valve body fluidly connected to the first air channel, the second air channel, and the third air channel, and a seal member configured to move relative to the valve body between a first position and a second position,
wherein in the first position, the seal member is configured to fluidly isolate the first air channel, the second air channel, and the third air channel, and
wherein in the second position, the seal member is configured to fluidly isolate the first air channel, and fluidly connect the second air channel and the third air channel.

17. The multiport airflow control manifold assembly of claim 16, wherein the first second port is fluidly connected to the first air channel upstream of the valve body and downstream of the first first port,
wherein the second second port is fluidly connected to the second air channel upstream of the valve body and downstream of the second first port, and
wherein the third second port is fluidly connected to the third air channel upstream of the valve body and downstream of the third first port.

18. The multiport airflow control manifold assembly of claim 16, wherein the first second port, the second second port, and the third second port are each configured to be fluidly connected to the air supply assembly.

19. The multiport airflow control manifold assembly of claim 16, wherein the first first port is configured to be fluidly connected to a first inflation zone of the cellular cushion, the second first port is configured to be fluidly connected to a second inflation zone of the cellular cushion, and the third first port is configured to be fluidly connected to a third inflation zone of the cellular cushion.

20. The multiport airflow control manifold assembly of claim 16, wherein the seal member is configured to move to a third position, wherein in the third position the seal member fluidly connects the first air channel, the second air channel, and the third air channel.
